(19) United States
(12) Patent Application Publication
(10) Pub. No.: US 2025/0230054 A1
(43) Pub. Date: Jul. 17, 2025

(54) NEGATIVE ELECTRODE ACTIVE MATERIAL FOR FLUORIDE-ION BATTERY AND METHOD FOR MANUFACTURING THEREOF, NEGATIVE ELECTRODE MIXTURE, AND FLUORIDE-ION BATTERY

(71) Applicants: TOYOTA JIDOSHA KABUSHIKI KAISHA, Toyota-shi (JP); HONDA MOTOR CO., LTD., Tokyo (JP)

(72) Inventors: Kousuke NOI, Uji-shi (JP); Takashi Nakagawa, Wako-shi (JP)

(73) Assignees: TOYOTA JIDOSHA KABUSHIKI KAISHA, Toyota-shi (JP); HONDA MOTOR CO., LTD., Tokyo (JP)

(21) Appl. No.: 18/982,100

(22) Filed: Dec. 16, 2024

(30) Foreign Application Priority Data
Jan. 11, 2024 (JP) 2024-002641

(51) Int. Cl. C01F 5/28; H01M 10/36

(52) U.S. Cl. CPC C01F 5/28; H01M 10/36; C01P 2002/72; C01P 2006/40

(57) ABSTRACT

An object of the present disclosure is to provide a negative electrode active material for a fluoride-ion battery capable of improving battery capacity, and a method for manufacturing thereof. The negative electrode active material for a fluoride-ion battery of the present disclosure is represented by the following formula (1): Mg₁₋ₓM^{III}ₓF₂₊ₓ (1), wherein, M^{III} is a trivalent metal, and x is greater than 0 and less than 0.5. The method for the present disclosure for manufacturing a negative electrode active material comprises the following steps: providing raw materials comprising a magnesium fluoride and a fluoride of the trivalent metal, and applying mechanical impact to the raw materials to cause them to react.

### FIELD

The present disclosure relates to a negative electrode active material for a fluoride-ion battery and a method for manufacturing thereof, a negative electrode mixture, and a fluoride-ion battery.

### BACKGROUND

Lithium-ion batteries, for example, are known as high-voltage and high-energy-density batteries, and are cation-based batteries using lithium ions as carriers. In contrast, fluoride-ion batteries using fluoride ions as carriers are known as anion-based batteries.

As disclosed in Patent literature 1, Patent literature 2 and Non-patent literature 1, studies have been made with a view to utilizing magnesium materials such as metallic magnesium or magnesium fluoride as negative electrode active materials of fluoride-ion batteries.

### CITATION LIST

### Patent Literature

[Patent literature 1] JP 2008-537312 JP
[Patent literature 2] JP 2022-123264 JP

### Non-Patent Literature

[Non-patent literature 1]. Journal of Materials Chemistry A, 2014, 2, 20861

### SUMMARY

### Technical Problem

In the case of fluoride-ion batteries comprising magnesium materials as negative electrode active materials, there is room for improvement of battery capacity.

An object of the present disclosure is to provide a negative electrode active material for a fluoride-ion battery capable of improving battery capacity, a method for manufacturing thereof, a negative electrode mixture comprising such a negative electrode active material, and a fluoride-ion battery comprising such a negative electrode mixture.

### Solution to Problem

The present inventors have found that the above object can be achieved by the following means.

### <Aspect 1>

A negative electrode active material for a fluoride-ion battery represented by the following formula (1):

Mg₁₋ₓM^{III}ₓF₂₊ₓ (1)
wherein, the formula (1), M^{III} is a trivalent metal, and x is greater than 0 and less than 0.5.

### <Aspect 2>

The negative electrode active material according to Aspect 1, wherein M^{III} is at least one selected from aluminum, scandium, gallium, yttrium, and lanthanoids.

### <Aspect 3>

A negative electrode mixture, comprising the negative electrode active material according to Aspect 1 or 2.

### <Aspect 4>

A fluoride-ion battery, comprising a negative electrode active material layer, wherein
the negative electrode active material layer comprises the negative electrode mixture according to Aspect 3.

### <Aspect 5>

A method for manufacturing the negative electrode active material according to Aspect 1, comprising the following step:
providing raw materials comprising a magnesium fluoride and a fluoride of the trivalent metal, and
applying mechanical impact to the raw materials to cause them to react.

### Advantageous Effects of Invention

According to the present disclosure, it is possible to provide a negative electrode active material for a fluoride-ion battery capable of improving battery capacity, a method for manufacturing thereof, a negative electrode mixture comprising such a negative electrode active material, and a fluoride-ion battery comprising such a negative electrode mixture.

### BRIEF DESCRIPTION OF DRAWINGS

FIG. 1 is a schematic cross-sectional view showing one example of the fluoride-ion battery of the present disclosure.

FIG. 2A is an XRD pattern of the negative electrode active material of Examples 1 to 5 and Example 12.

FIG. 2B is an XRD pattern of the negative electrode active material of Examples 6 to 11.

FIG. 2C is an XRD pattern of the negative electrode active material of Comparative Examples 1 to 3.

FIG. 3A is a charge-discharge curve of the battery of Example 1.

FIG. 3B is a charge-discharge curve of the battery of Example 2.

FIG. 3C is a charge-discharge curve of the battery of Example 3.

FIG. 3D is a charge-discharge curve of the battery of Example 4.

FIG. 3E is a charge-discharge curve of the battery of Example 5.

FIG. 3F is a charge-discharge curve of the battery of Example 6.

FIG. 3G is a charge-discharge curve of the battery of Example 7.

FIG. 3H is a charge-discharge curve of the battery of Example 8.

FIG. 3I is a charge-discharge curve of the battery of Example 9.

FIG. 3J is a charge-discharge curve of the battery of Example 10.

FIG. 3K is a charge-discharge curve of the battery of Example 11.

FIG. 3L is a charge-discharge curve of the battery of Example 12.

FIG. 3M is the charge-discharge curve of the battery of Comparative Example 1.

FIG. 3N is the charge-discharge curve of the battery of Comparative Example 2.

FIG. 3O is the charge-discharge curve of the battery of Comparative Example 3.

### DESCRIPTION OF EMBODIMENTS

Hereinafter, embodiments of the present disclosure will be described in detail. The present disclosure is not limited to the following embodiments, and various modifications can be made within the scope of the disclosure.

### <<Negative Electrode Active Material for Fluoride-Ion Battery>>

The negative electrode active material for a fluoride-ion battery of the present disclosure is represented by the following formula (1):

Mg₁₋ₓM^{III}ₓF₂₊ₓ (1)
wherein, the formula (1), M^{III} is a trivalent metal, and x is less than 0.5.

The present disclosers have found that when magnesium fluoride is used as a negative electrode active material, although the theoretical value of the battery capacity is large, it is difficult to make the actual value sufficiently large. The present disclosers have considered that one reason a sufficient battery capacity cannot be obtained when magnesium fluoride is used as a negative electrode active material is that diffusion of fluoride ions inside the magnesium fluoride is slow and only regions near the surface of the negative electrode active material particles can contribute to the electrode reaction.

In this regard, the present disclosers have found that, by introducing cations having a higher valence than magnesium ions into magnesium fluoride at a predetermined ratio to form a composite fluoride, the capacity of a battery comprising this composite fluoride as a negative electrode active material is improved. Although not intended to be bound by any theory, the reason therefor is believed to be as follows. Specifically, by introducing the above cations while maintaining the crystal structure of magnesium fluoride, the fluoride ions in the above composite fluoride become more excessive than those in unsubstituted magnesium fluoride for charge compensation. These excess fluoride ions are considered to exist in the interstices of the magnesium fluoride crystal. It is considered that a new diffusion path is constructed between the fluoride ions existing in this interstices and those at the lattice positions, so that the diffusion of the fluoride ions becomes faster. As a result, it is considered that the electrode reaction proceeds not only on the surface of the negative electrode active material particles, but also to the inside thereof, thereby improving the battery capacity.

In Formula (1), Mg is metallic magnesium and F is fluorine.

In Formula (1), M^{III} may be at least one species selected from aluminum, scandium, gallium, yttrium, and lanthanoids. Examples of lanthanoids include samarium, neodymium, and europium.

In Formula (1), x is greater than 0 and less than 0.5. In this case, the excess fluoride ions present in the interstices are at an appropriate concentration, resulting in faster diffusion of fluoride ions. Also, when x is less than 0.5, magnesium can be replaced by M^{III} while maintaining the crystal structure of magnesium fluoride. The metals that can be used as M^{III} vary in valency type and atomic size, so x may vary, depending on the type of M^{III}. For example, if M^{III} is aluminum, gallium, yttrium, and lanthanoids, x may be greater than 0, 0.1 or greater, or 0.2 or greater, and 0.4 or less, 0.3 or less, 0.2 or less, or 0.1 or less. If M^{III} is scandium, x may be greater than 0, 0.1 or greater, 0.2 or greater, or 0.3 or greater, and 0.4 or less, or 0.3 or less.

### <<Manufacturing Method for Negative Electrode Active Material>>

The method for the present disclosure for manufacturing a negative electrode active material comprises the following steps: providing raw materials comprising a magnesium fluoride and a fluoride of the trivalent metal, and applying mechanical impact to the raw materials to cause them to react.

### <Raw Material Provision Step>

The method for the present disclosure comprises providing raw materials comprising magnesium fluoride and a fluoride of the trivalent metal.

In the method for the present disclosure, the trivalent metal is MIMI described above.

### <Reaction Step>

The method for the present disclosure comprises applying mechanical impact to the raw materials to cause them to react.

Examples of the method for applying mechanical impact include a mechanical milling method, and specifically examples thereof include a method for mixing by a ball mill. In addition, this reaction step can be performed in an inert atmosphere, for example, a dry argon atmosphere.

### <<Negative Electrode Composite Material>>

The negative electrode mixture of the present disclosure comprises a negative electrode active material of the present disclosure, and optionally comprises a fluoride ion conductive material, a conductive aid, and a binder.

A “negative electrode mixture” relating to the present disclosure means a composition that can constitute a negative electrode active material layer as-is or by further containing an additional component.

### <Negative Electrode Active Material>

For the negative electrode active material of the present disclosure, the above description relating to the negative electrode active material of the present disclosure can be referred to.

The content of the negative electrode active material in the negative electrode mixture may be 10% by mass or more, 20% by mass or more, 30% by mass or more, or 40% by mass or more, and may be 90% by mass or less, 80% by mass or less, 70% by mass or less, 60% by mass or less, or 50% by mass or less.

### <Fluoride Ion Conductive Material>

The negative electrode mixture comprises a fluoride ion conductive material comprising at least one kind of metal element (excluding metallic magnesium) and fluorine. The fluoride ion conductive material has fluoride ion conductivity. In addition, a part or all of the fluoride ion conductive material may function as a negative electrode active material during charging and discharging.

Fluoride ion conductive material may include, for example, barium calcium fluoride (Ca₁₋ₓBaₓF₂). x may be 0.30 or more, 0.35 or more, 0.40 or more, or 0.45 or more, and may be 0.70 or less, 0.65 or less, 0.60 or less, or 0.65 or less.

The content of the fluoride ion conductive material in the negative electrode mixture may be 10% by mass or more, 20% by mass or more, 30% by mass or more, 40% by mass or more, or 45% by mass, and may be 90% by mass or less, 80% by mass or less, 70% by mass or less, 60% by mass or less, or 55% by mass or less.

### <Conductive Aids>

Examples of the conductive aid include carbon materials. Examples of carbon materials include carbon black such as acetylene black, Ketjen black, furnace black, and thermal black, graphene, fullerene, and carbon nanotubes.

### <Binder>

Examples of the binder include fluorine-based binders such as polyvinylidene fluoride (PVdF) and polytetrafluoroethylene (PTFE).

### <<Fluoride-Ion Battery>>

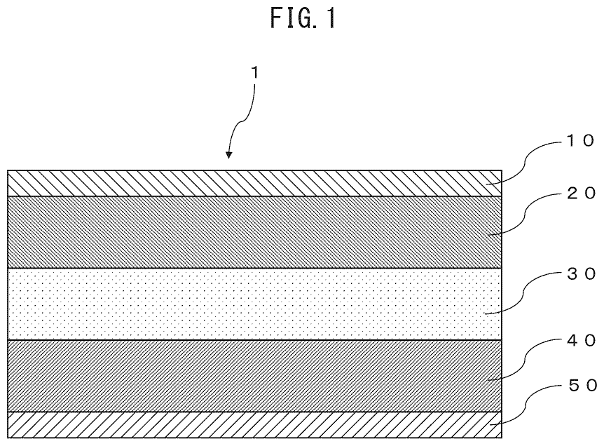

As shown in FIG. 1, the fluoride-ion battery 1 of the present disclosure comprises a negative electrode active material layer 20, and the negative electrode active material layer comprises a negative electrode mixture of the present disclosure. The fluoride-ion battery 1 of the present disclosure may comprise a negative electrode current collector 10, a negative electrode active material layer 20, an electrolyte layer 30, a positive electrode current collector 40, and a positive electrode active material layer 50 in this order.

The fluoride-ion battery of the present disclosure may be a liquid battery or solid-state battery. It should be noted that, with respect to the present disclosure, a “solid-state battery” means a battery using at least a solid electrolyte as an electrolyte, and therefore, a solid-state battery may use a combination of a solid electrolyte and a liquid electrolyte as an electrolyte.

### <Negative Electrode Current Collector>

Examples of the material of the negative electrode current collector include stainless steel (SUS), copper, nickel, iron, titanium, platinum, and carbon. Examples of the form of the negative electrode current collector include a foil, a mesh, and a porous material.

### <Negative Electrode Active Material Layer>

The negative electrode active material layer comprises a negative electrode mixture of the present disclosure. For the negative electrode mixture of the present disclosure, reference can be made to the above description relating to the negative electrode mixture of the present disclosure.

The thickness of the negative electrode active material layer is not particularly limited and can be appropriately adjusted according to the configuration of the battery.

### <Electrolyte Layer>

When the fluoride-ion battery of the present disclosure is a liquid-based battery, the electrolyte layer may be composed of, for example, an electrolytic solution and an optional separator.

The electrolytic solution can contain, for example, a fluoride salt and an organic solvent.

The separator is not particularly limited, as long as the composition thereof is composed to withstand the use range of a fluoride-ion battery.

When the fluoride-ion battery of the present disclosure is a solid-state battery, the electrolyte layer may be a layer comprising a solid electrolyte, for example. In this case, the electrolyte layer may optionally comprise a binder.

The solid electrolyte is not particularly limited, as long as it is a material which can be used in a fluoride-ion battery, but an inorganic fluoride is exemplified. Examples of inorganic fluoride include Ca₁₋ₓBaₓF₂.

For the binder, reference can be made to the above description relating to the negative electrode mixture of the present disclosure.

### <Positive Electrode Active Material Layer>

The positive electrode active material layer of the present disclosure is a layer comprising at least a positive electrode active material. The positive electrode active material layer may optionally include a solid electrolyte, a conductive aid, and a binder.

The positive electrode active material is generally an active material that is defluorinated during discharge. Examples of the positive electrode active material include elemental metals, alloys, metal oxides, and fluorides thereof. Examples of the metallic element comprised in the positive electrode active material can include Cu, Ag, Ni, Co, Pb, Mn, Au, Pt, Rh, V, Os, Ru, Fe, Cr, Bi, Nb, Sb, Ti, Sn, and Zn.

For the solid electrolyte, the above description regarding the electrolyte layer of the present disclosure can be referred to, and for the conductive aid and the binder, the above description regarding the negative electrode mixture of the present disclosure can be referred to.

The thickness of the positive electrode active material layer is not particularly limited and can be appropriately adjusted according to the configuration of the battery.

### <Positive Electrode Current Collector>

Examples of the material of the positive electrode current collector layer include lead, stainless steel (SUS), aluminum, nickel, iron, titanium, platinum, and carbon. Examples of the form of the positive electrode current collector layer include a foil, a mesh, and a porous material.

### EXAMPLES

### Example 1

### <Preparation of Negative Electrode Active Material>

Predetermined amounts of magnesium fluoride (MgF₂) and aluminum fluoride (AlF₃) were mixed and reacted by mechanical milling method using a ball mill device (planetary series ball mill premium line PL-7, manufactured by Fritsch GmbH) to obtain a powdery negative electrode active material Mg_{0.9}Al_{0.1}F_{2.1} (MgF₂:AlF₃=9:1 (molar ratio)). Mixing by a ball mill was carried out over 20 hours in a 600 rpm, in a dry-argon atmosphere.

### <Preparation of Negative Electrode Mixture Material>

Predetermined amounts of calcium fluoride (CaF₂) and barium fluoride (BaF₂) were mixed and reacted by mechanical milling method using a ball mill device (planetary series ball mill premium line PL-7, manufactured by Fritsch GmbH) to obtain powdery fluoride ion conductive material Ca_{0.5}Ba_{0.5}F₂ (50CaF₂/50BaF₂ (mol %). Mixing by a ball mill was carried out over 20 hours in a 600 rpm, in a dry-argon atmosphere. The negative electrode active material and the fluoride ion conductive material described above, and acetylene black (AB) as a conductive aid were weighed at a mass ratio of 45:48:7 and mixed by a ball mill using a ball mill device (planetary series ball mill premium line PL-7, manufactured by Fritsch GmbH) to obtain a powdery negative electrode mixture. Mixing by a ball mill was carried out over 3 hours in a 600 rpm, in a dry-argon atmosphere.

### <Preparation of Solid Electrolyte>

Predetermined amounts of CaF₂ and BaF₂ were mixed by the mechanical milling method using a ball-milling device (planetary series ball mill premium line PL-7, manufactured by Fritsch GmbH) to obtain powdery solid electrolyte Ca_{0.6}Ba_{0.4}F₂ (60CaF₂/40BaF₂ (mol %)). Mixing by a ball mill was carried out for 20 hours in a 600 rpm, in a dry-argon atmosphere.

<Production of all-Solid-State Fluoride-Ion Battery>

10 mg of the powdery negative electrode mixture described above was used to form a green compact, thereby obtaining negative electrode active material layer. 100 mg of the powdery solid electrolyte described above was used to form a green compact, thereby obtaining electrolyte layer. 220 mg of a lead (Pb) metallic plate functioning as a positive electrode active material was used as the positive electrode active material layer. A platinum foil as a negative electrode current collector, a negative electrode active material layer, an electrolyte layer, a positive electrode active material layer, and an aluminum foil as a positive electrode current collector were laminated in this order to prepare an all-solid-state fluoride-ion battery of Example 1. The diameter of all-solid-state fluoride-ion battery was 11.28 mm. This all-solid-state fluoride-ion battery was arranged in a cylindrical ceramic container with an inner diameter of 11.28 mm and was secured by being sandwiched between stainless steel cylinders, each with a diameter of 11.28 mm, on both sides by the negative and positive current collectors.

### Example 2

All-solid-state fluoride-ion battery of Example 2 was produced in the same manner as in Example 1 except that the composition of the negative electrode active material was changed to Mg_{0.7}Al_{0.3}F_{2.3} (MgF₂:AlF₃=7:3 (molar ratio)).

### Examples 3 to 12

All-solid-state fluoride-ion batteries from examples 3 to 12 were produced in the same manner as in Example 1, except that gallium fluoride (GaF₃), scandium fluoride (ScF₃), yttrium fluoride (YF₃), neodymium fluoride (NdF₃), samarium fluoride (SmF₃), or europium fluoride (EuF₃) were used instead of AlF₃ as a reagent used for preparing the negative electrode active material, and the composition of the negative electrode active material was changed as shown in Table 1.

### Comparative Example 1

An all-solid-state fluoride-ion battery of Comparative Example 1 was produced in the same manner as in Example 1, except that a MgF₂ not substituted with a trivalent metal (M^{III}), that is, an unsubstituted MgF₂, was used as the negative electrode active material.

### Comparative Examples 2 and 3

An all-solid-state fluoride-ion batteries of Comparative Examples 2 and 3 were produced in the same manner as in Example 1, except that sodium fluoride (NaF) or potassium fluoride (KF) was used instead of AlF₃ as a reagent used for preparing the negative electrode active material, and the composition of the negative electrode active material was changed as shown in Table 1

### <<Evaluation>>

### <Confirmation of Element Substitution>

Whether MgF₂ with partially substituted elements was prepared was determined by X-ray diffraction (XRD) analysis. This was confirmed by verifying that the negative electrode active material had the same crystal phase (tetragonal MgF₂ phase) as MgF₂ and that the lattice constants and lattice volume of the crystal phase had changed from those of unsubstituted MgF₂. The lattice constants and lattice volume were determined by pattern fitting of XRD patterns.

### (XRD Measurement)

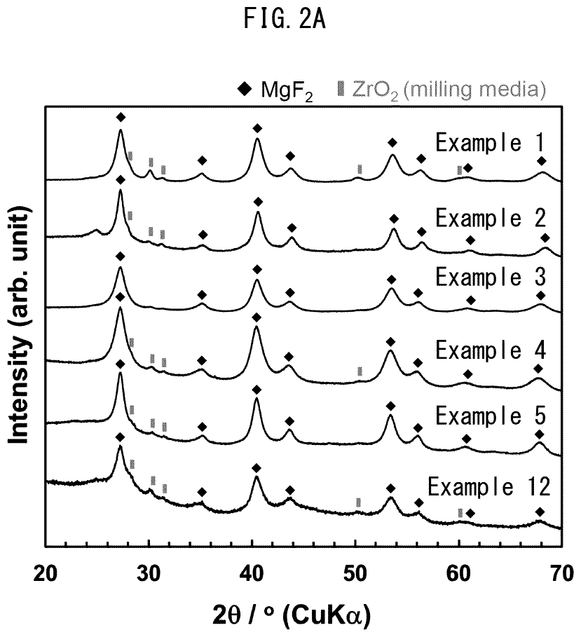

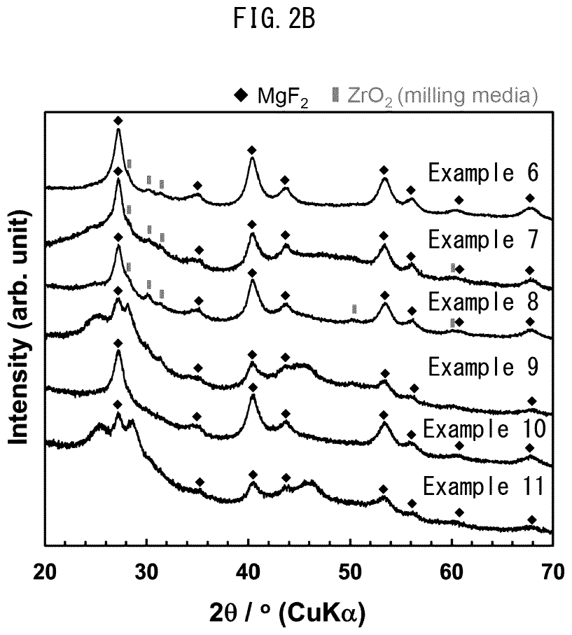

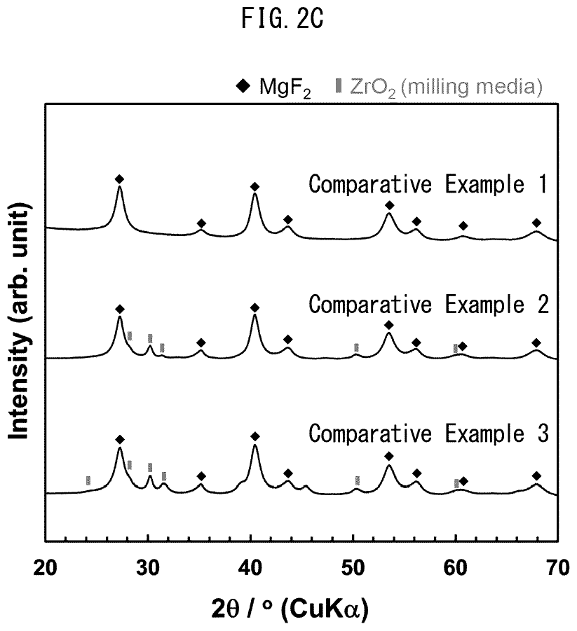

XRD was measured on the negative electrode active material of the respective examples. Specifically, measurements were carried out by a parafocusing method with CuKα radiation, using the SmartLab apparatus manufactured by Rigaku Corporation, under conditions of a tube voltage of 45 kV and a tube current of 200 mA. The results are shown in FIG. 2. As shown in FIG. 2, in all samples, the peaks attributed to the tetragonal MgF₂ phase were observed.

For each obtained XRD pattern, the lattice constants and lattice volume of the MgF₂ phase were calculated by performing pattern fitting analysis using the analysis software PDXL made by Rigaku. The results are shown in Table 1.

TABLE 1

| | | lattice | lattice | lattice |
|---|---|---|---|---|
| | negative electrode | constant | constant | volume |
| | active material | a, b [Å] | c [Å] | [Å3] |
| Example 1 | Mg_{0.9}Al_{0.1}F_{2.1} | 4.62 | 3.041 | 64.92 |
| Example 2 | Mg_{0.7}Al_{0.3}F_{2.3} | 4.61 | 3.034 | 64.48 |
| Example 3 | Mg_{0.9}Ga_{0.1}F_{2.1} | 4.645 | 3.043 | 65.66 |
| Example 4 | Mg_{0.9}Sc_{0.1}F_{2.1} | 4.656 | 3.051 | 66.14 |
| Example 5 | Mg_{0.7}Sc_{0.3}F_{2.3} | 4.664 | 3.057 | 66.49 |
| Example 6 | Mg_{0.9}Y_{0.1}F_{2.1} | 4.662 | 3.056 | 66.40 |
| Example 7 | Mg_{0.7}Y_{0.3}F_{2.3} | 4.664 | 3.057 | 66.50 |
| Example 8 | Mg_{0.9}Nd_{0.1}F_{2.1} | 4.648 | 3.059 | 66.08 |
| Example 9 | Mg_{0.7}Nd_{0.3}F_{2.3} | 4.695 | 3.042 | 67.07 |
| Example 10 | Mg_{0.9}Sm_{0.1}F_{2.1} | 4.649 | 3.054 | 66.01 |
| Example 11 | Mg_{0.7}Sm_{0.3}F_{2.3} | 4.662 | 3.047 | 66.22 |
| Example 12 | Mg_{0.9}Eu_{0.1}F_{2.1} | 4.654 | 3.055 | 66.16 |
| Comparative | MgF₂ | 4.619 | 3.053 | 65.14 |
| Example 1 | | | | |
| Comparative | Mg_{0.9}Na_{0.1}F_{1.9} | 4.646 | 3.053 | 65.90 |
| Example 2 | | | | |
| Comparative | Mg_{0.9}K_{0.1}F_{1.9} | 4.643 | 3.049 | 65.71 |
| Example 3 | | | | |

In the samples of each example, the lattice constants and the lattice volume changed compared to the unsubstituted MgF₂ phase. From the above, it was confirmed that MgF₂ with partially substituted elements was prepared. In several samples, minor peaks attributed to ZrO₂ were observed. This is an impurity derived from the media of the ball mill. Peaks that do not indicate attribution by symbols are peaks derived from the unreacted portions of each raw material (e.g., AlF₃ in Example 2, NdF₃ in Example 9, and SmF₃ in Example 11). The above-mentioned ZrO₂ and unreacted portions of the raw materials are trace components and are not considered to significantly affect the properties.

### <Evaluation of Fluoride-Ion Battery>

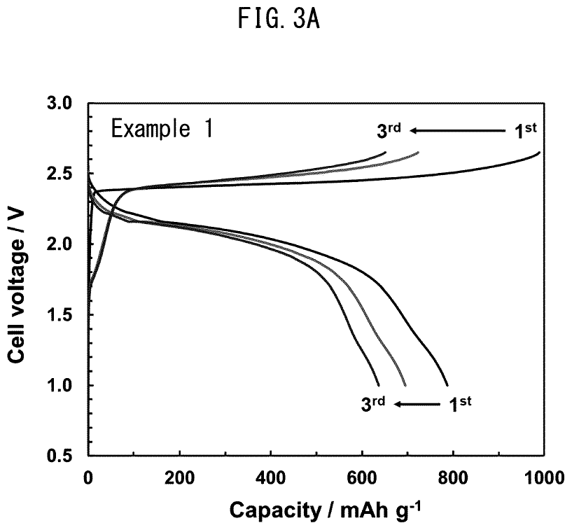

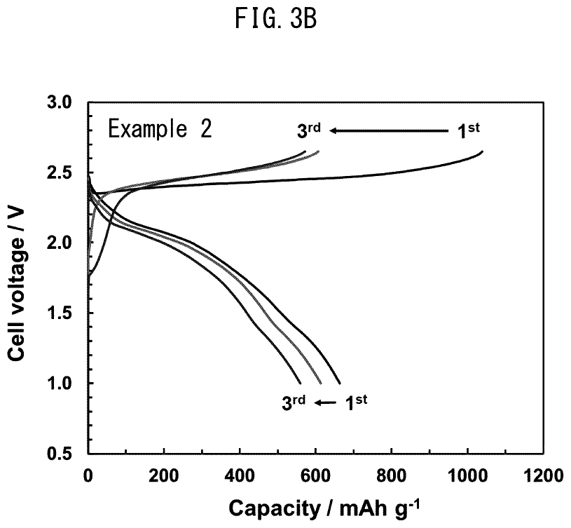

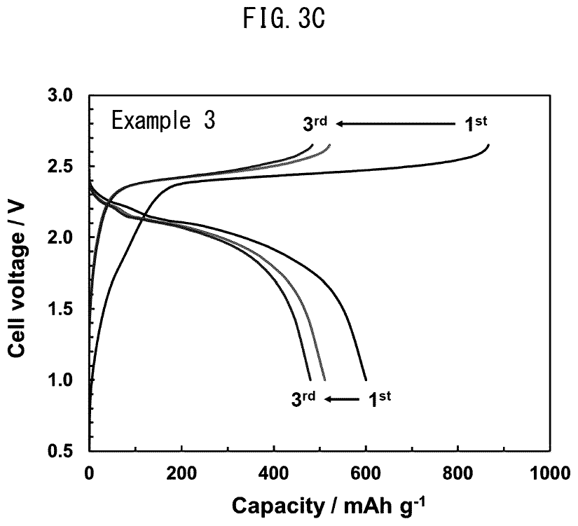

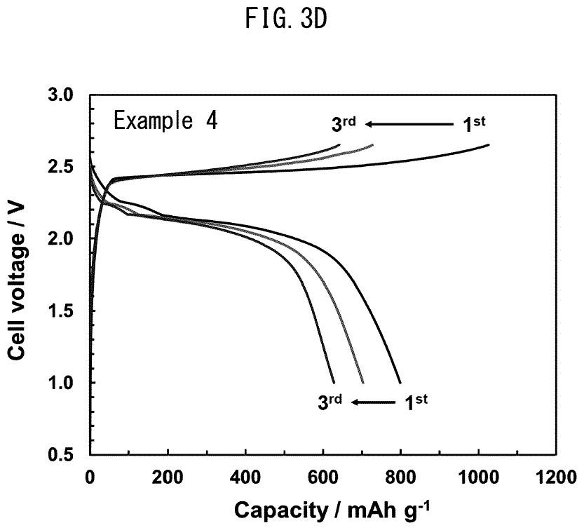

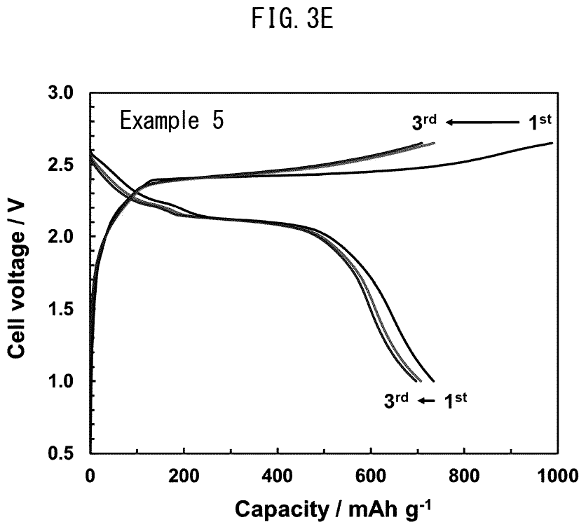

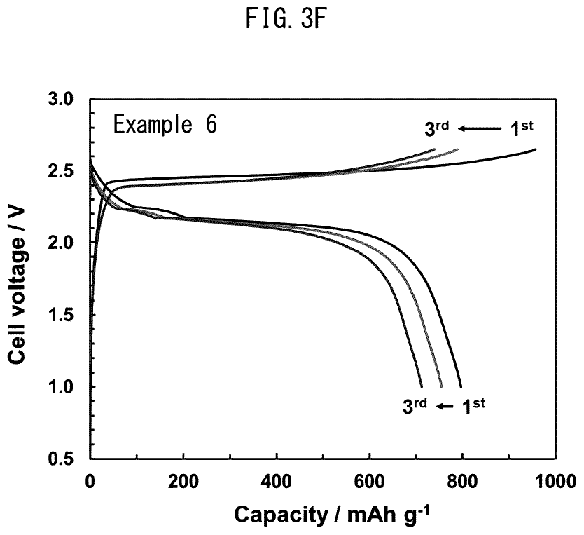

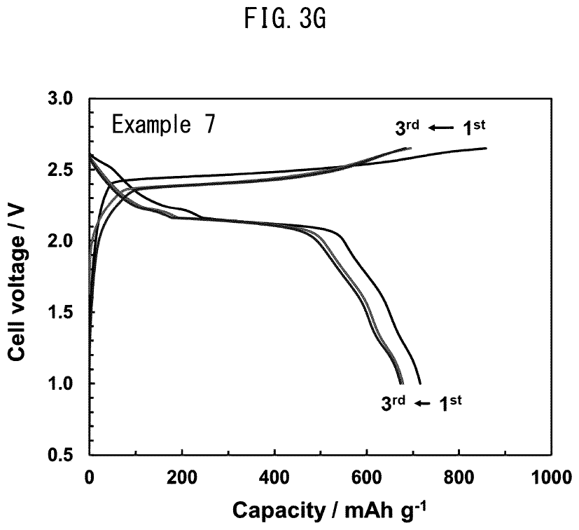

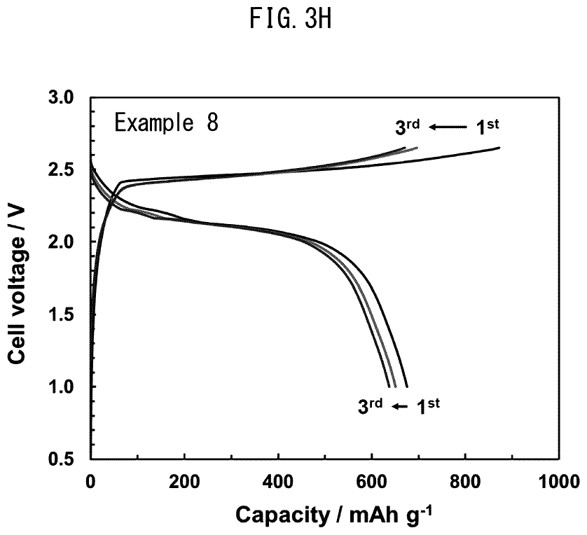

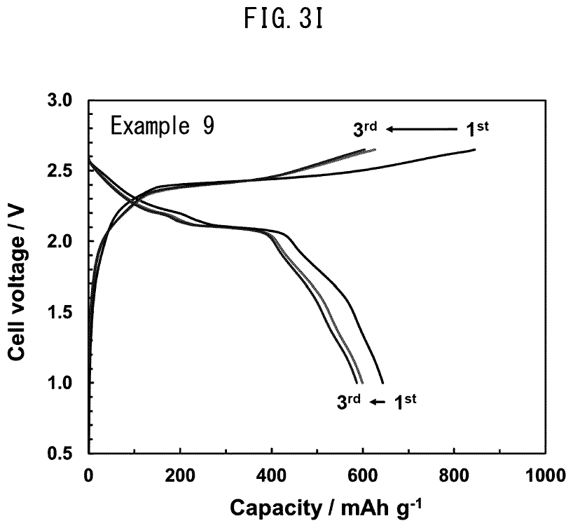

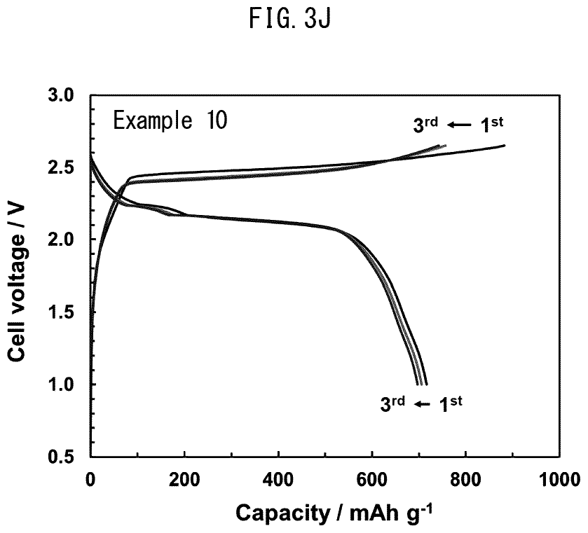

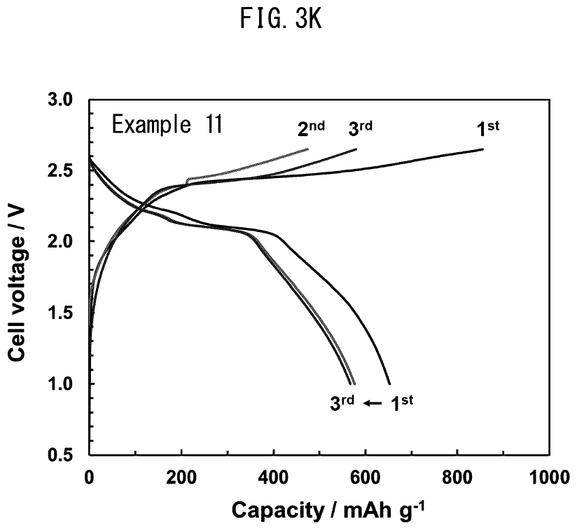

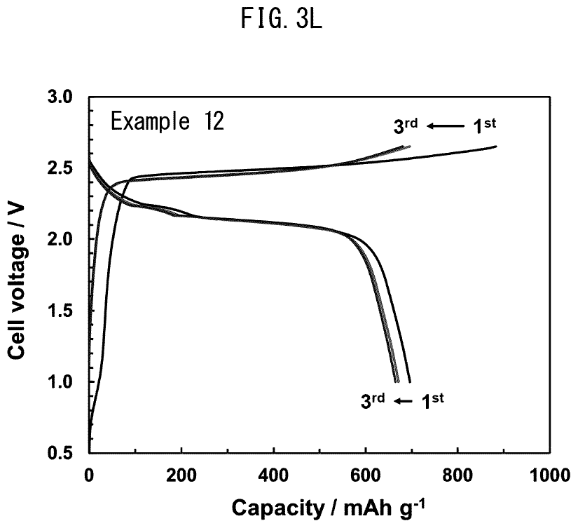

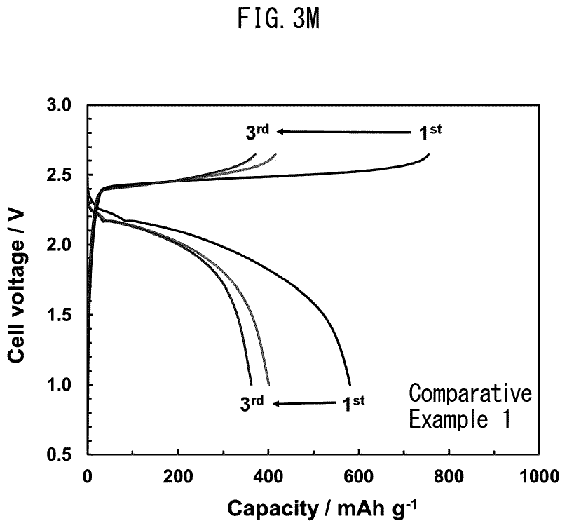

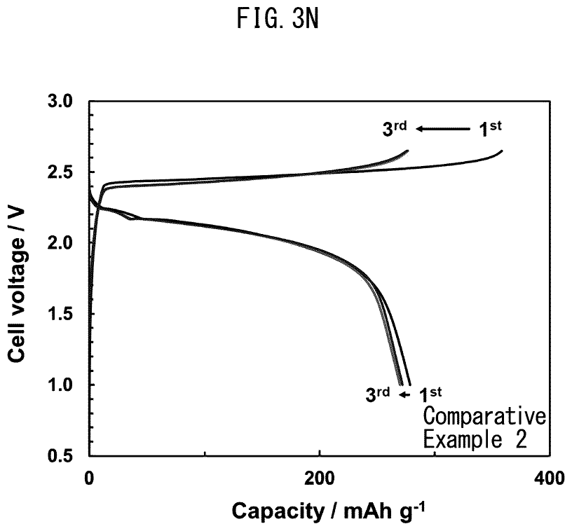

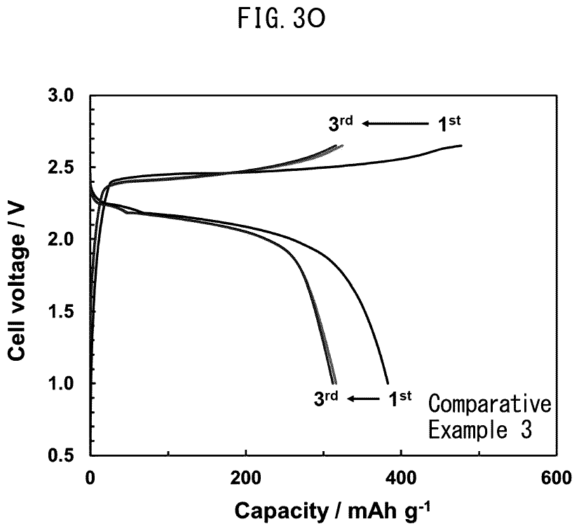

The fluoride-batteries of each example were each charged and discharged three times each at a test temperature of 200° C. and a current density of 0.05 mA/cm² while evacuated in a sealed container. The end-of-charge voltage and end-of-discharge voltage were 2.65 V and 1.0 V, respectively. An electrochemical measurement system equipped with a frequency response analyzer (VMP-300 high-performance electrochemical measurement system, manufactured by Bio-Logic Science Instruments Ltd.) was used for the charge-discharge test. The results of the charge and discharge test are shown in Table 2 and FIG. 3. The charge capacity and discharge capacity of each example are specific capacities standardized by the mass of the negative electrode active material in the negative electrode mixture.

TABLE 2

| | | capacity [mAh g⁻¹] | | | | | |
|---|---|---|---|---|---|---|---|
| | negative electrode | 1st | 1st | 2nd | 2nd | 3rd | 3rd |
| | active material | charge | discharge | charge | discharge | charge | discharge |
| Example 1 | Mg_{0.9}Al_{0.1}F_{2.1} | 989 | 787 | 723 | 695 | 651 | 637 |
| Example 2 | Mg_{0.7}Al_{0.3}F_{2.3} | 1039 | 663 | 607 | 613 | 572 | 560 |
| Example 3 | Mg_{0.9}Ga_{0.1}F_{2.1} | 866 | 600 | 521 | 511 | 484 | 480 |
| Example 4 | Mg_{0.9}Sc_{0.1}F_{2.1} | 1026 | 798 | 727 | 703 | 641 | 628 |
| Example 5 | Mg_{0.7}Sc_{0.3}F_{2.3} | 987 | 734 | 735 | 707 | 709 | 697 |
| Example 6 | Mg_{0.9}Y_{0.1}F_{2.1} | 957 | 797 | 789 | 755 | 740 | 712 |
| Example 7 | Mg_{0.7}Y_{0.3}F_{2.3} | 858 | 716 | 695 | 678 | 684 | 673 |
| Example 8 | Mg_{0.9}Nd_{0.1}F_{2.1} | 872 | 675 | 697 | 651 | 671 | 637 |
| Example 9 | Mg_{0.7}Nd_{0.3}F_{2.3} | 845 | 644 | 627 | 599 | 604 | 587 |
| Example 10 | Mg_{0.9}Sm_{0.1}F_{2.1} | 882 | 717 | 757 | 706 | 742 | 697 |
| Example 11 | Mg_{0.7}Sm_{0.3}F_{2.3} | 855 | 653 | 474 | 577 | 580 | 567 |
| Example 12 | Mg_{0.9}Eu_{0.1}F_{2.1} | 883 | 696 | 696 | 671 | 681 | 665 |
| Comparative | MgF₂ | 755 | 581 | 416 | 401 | 371 | 362 |
| Example 1 | | | | | | | |
| Comparative | Mg_{0.9}Na_{0.1}F_{1.9} | 358 | 279 | 277 | 270 | 276 | 272 |
| Example 2 | | | | | | | |
| Comparative | Mg_{0.9}K_{0.1}F_{1.9} | 477 | 383 | 324 | 316 | 316 | 312 |
| Example 3 | | | | | | | |

As shown in Table 2 and FIG. 3, the batteries in the Examples that used MgF₂ partially substituted with trivalent metal (Mg₁₋ₓM^{III}ₓF₂₊ₓ) as a negative electrode active material had a larger specific capacity. On the other hand, batteries in the Comparative Examples that used unsubstituted MgF₂ or MgF₂ partially substituted with monovalent metal (Mg₁₋ₓM^{I}ₓF₂₊ₓ) as a negative electrode active material had a smaller specific capacity.

### REFERENCE SIGNS LIST

1 fluoride-ion battery
10 negative electrode current collector
20 negative electrode active material layer
30 electrolyte layer
40 positive electrode active material layer
50 positive electrode current collector

1. A negative electrode active material for a fluoride-ion battery, represented by the following formula (1):
Mg₁₋ₓM^{III}ₓF₂₊ₓ (1)
wherein, M^{III} is a trivalent metal, and x is greater than 0 and less than 0.5.

2. The negative electrode active material according to claim 1, wherein M^{III} is at least one selected from aluminum, scandium, gallium, yttrium, and lanthanoids.

3. A negative electrode mixture, comprising the negative electrode active material according to claim 1.

4. A fluoride-ion battery, comprising a negative electrode active material layer, wherein
the negative electrode active material layer comprises the negative electrode mixture according to claim 3.

5. A method for manufacturing the negative electrode active material according to claim 1, comprising the following step:
providing raw materials comprising a magnesium fluoride and a fluoride of the trivalent metal, and
applying mechanical impact to the raw materials to cause them to react.
